(19) United States
(12) Patent Application Publication
(10) Pub. No.: US 2011/0012723 A1
(43) Pub. Date: Jan. 20, 2011

(54) EMBEDDED IN TIRE SELF-POWERED SEMI-PASSIVE RFID TRANSPONDER

(76) Inventors: John David Adamson, Simpsonville, SC (US); George P. O'Brien, Piedmont, SC (US)

Correspondence Address: DORITY & MANNING, PA & MICHELIN NORTH AMERICA, INC, P O BOX 1449, GREENVILLE, SC, 29602-1449, US

(21) Appl. No.: 12/922,937

(22) PCT Filed: Mar. 31, 2008
(86) PCT No.: PCT/US08/58860

§ 371 Date: Sep. 16, 2010

(51) Int. Cl. B60C 23/00

(52) U.S. Cl. 340/447

(57) ABSTRACT

Disclosed is an apparatus and methodology for providing a semi-passive transponder system in a vehicle. A semi-passive module employing backscatter technology is provided with an internal energy source that provides operating energy for at least a portion of the modules operating circuitry to reduce the energy requirements of a corresponding interrogator device. The module may be associated with tires mounted on a vehicle such that bi-directional communications may be established between the module and a centrally located interrogator module on the vehicle. The internal energy source may correspond to a battery, a fuel cell, a rechargeable device, an energy harvesting device, or similar devices.

### FIELD OF THE INVENTION

The present subject matter related to transponders mounted in tires. More specifically, the subject matter relates to methodologies and apparatus for providing on board energy assisted communication for a backscatter transponder system mounted in a vehicle mounted tire.

### BACKGROUND OF THE INVENTION

In the prior art, many schemes have been presented to communicate data between a vehicle and a rotating tire. The presently used methods have significant limitations in terms of cost and performance. A common architecture found in the prior art, a transmitter and central receiver architecture, consists of an active transmitter integrated into a tire that communicates with a central receiver mounted on or in a vehicle. One advantage of this approach is that the overall system cost is relatively low since there are no electronics in the wheel well. There are, however, disadvantages including limited one-way communications from the tire to the vehicle only, transmitter on time limitations, data update rate limitations, world wide radio frequency regulation variations including active RF source certification variations.

In those instances where two-way communication is required, the inclusion of a separate receiver in tire modules is a complicating factor. These complications stem from the fact that a receiver does not know when a vehicle transceiver is going to transmit so that the receiver must remain turned on for long periods so that energy requirements become unrealistic. Further the provision of automotive grade receivers functional to, for example, 120° C. is expensive.

Another common architecture currently employed, an initiator architecture, consists of tire electronics that are powered from a local radio frequency (RF) source mounted in each wheel well. This solution works technically and it allows for the possibility of two-way communications and fast data update rates. However, the vehicle architecture is expensive due to the electronics and cabling required in each wheel well. Furthermore, some OEMs have a maximum operating temperature specification of 120° C. for wheel well electronics. This operating temperature requirement increases the overall system costs because specialized components are required.

In view of these known problems associated with previously known architectures, it would be advantageous if a new architecture were developed that permitted two-way communications and fast update rates while maintaining relatively low energy consumption.

While various implementations of tire transponder systems have been developed, no design has emerged that generally encompasses all of the desired characteristics as hereafter presented in accordance with the subject technology.

### SUMMARY OF THE INVENTION

In view of the recognized features encountered in the prior art and addressed by the present subject matter, improved methodology and apparatus for providing improved communications in a vehicle mounted back-scatter transceiver system has been developed.

Particular embodiments of the present subject matter include a vehicle mounted semi-passive transponder system comprising a vehicle, at least one semi-passive backscatter module associated with the vehicle, and an interrogator module. In certain embodiments the interrogator may be located on the vehicle. In other embodiments the interrogator module may correspond to a handheld device or a drive by device. The semi-passive module includes an antenna, an antenna impedance modulator, a data encoder, a data decoder, a memory, and an internal energy source which is configured to supply power to at least the antenna impedance modulator.

The method of the present subject matter comprises providing improved communications for a vehicle mounted back-scatter transceiver system by providing a vehicle, providing a semi-passive backscatter module by providing an antenna, an antenna impedance modulator, a data encoder, a data decoder, a memory, and an internal energy source for providing energy to at least the antenna impedance modulator, associating at least one provided semi-passive backscatter module with a vehicle, locating an interrogator module on the vehicle, and coupling the interrogator module to the vehicle. In other embodiments of the present subject matter, the interrogator module may be provided as a handheld device or a drive by device rather than being mounted on the vehicle.

In other particular embodiments the internal energy source may correspond to a battery, a fuel cell, a radiation source, a super-capacitor or a rechargeable battery. In further embodiments the energy source may correspond to energy harvesting devices including piezoelectric devices, thermo-electric transducers, and RF energy harvesting devices including combinations of internal devices with initiators mounted in vehicle wheel wells, hand held type devices, and drive-by units.

In still other particular embodiments, the semi-passive backscatter modules may include other internal components including data encoder/decoder devices, memory devices, microcontrollers, sensors and other such components that may in whole or in part be supplied operating energy from the internal energy source.

Additional objects and advantages of the present subject matter are set forth in, or will be apparent to, those of ordinary skill in the art from the detailed description herein. Also, it should be further appreciated that modifications and variations to the specifically illustrated, referred and discussed features and elements hereof may be practiced in various embodiments and uses of the invention without departing from the spirit and scope of the subject matter. Variations may include, but are not limited to, substitution of equivalent means, features, or steps for those illustrated, referenced, or discussed, and the functional, operational, or positional reversal of various parts, features, steps, or the like.

Still further, it is to be understood that different embodiments, as well as different presently preferred embodiments, of the present subject matter may include various combinations or configurations of presently disclosed features, steps, or elements, or their equivalents (including combinations of features, parts, or steps or configurations thereof not expressly shown in the figures or stated in the detailed description of such figures). Additional embodiments of the present subject matter, not necessarily expressed in the summarized section, may include and incorporate various combinations of aspects of features, components, or steps referenced in the summarized objects above, and/or other features, components, or steps as otherwise discussed in this application. Those of ordinary skill in the art will better appreciate the features and aspects of such embodiments, and others, upon review of the remainder of the specification.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 illustrates a transponder communications system in accordance with the present technology;

FIG. 2 illustrates a vehicle with a centrally located transceiver and four tires each containing a transponder;

FIG. 3 illustrates a previously employed passive transponder configured to derive operating power from an external source;

FIG. 4 illustrates an encoder and antenna modulator in accordance with the present technology; and

FIG. 5 illustrates a semi-passive transponder including a local energy source in accordance with present technology.

Repeat use of reference characters throughout the present specification and appended drawings is intended to represent same or analogous features or elements of the invention.

### DETAILED DESCRIPTION OF THE PREFERRED EMBODIMENTS

As discussed in the Summary of the Invention section, the present subject matter is particularly concerned with semi-passive transponder systems associated with vehicles.

Selected combinations of aspects of the disclosed technology correspond to a plurality of different embodiments of the present invention. It should be noted that each of the exemplary embodiments presented and discussed herein should not insinuate limitations of the present subject matter. Features or steps illustrated or described as part of one embodiment may be used in combination with aspects of another embodiment to yield yet further embodiments. Additionally, certain features may be interchanged with similar devices or features not expressly mentioned which perform the same or similar function.

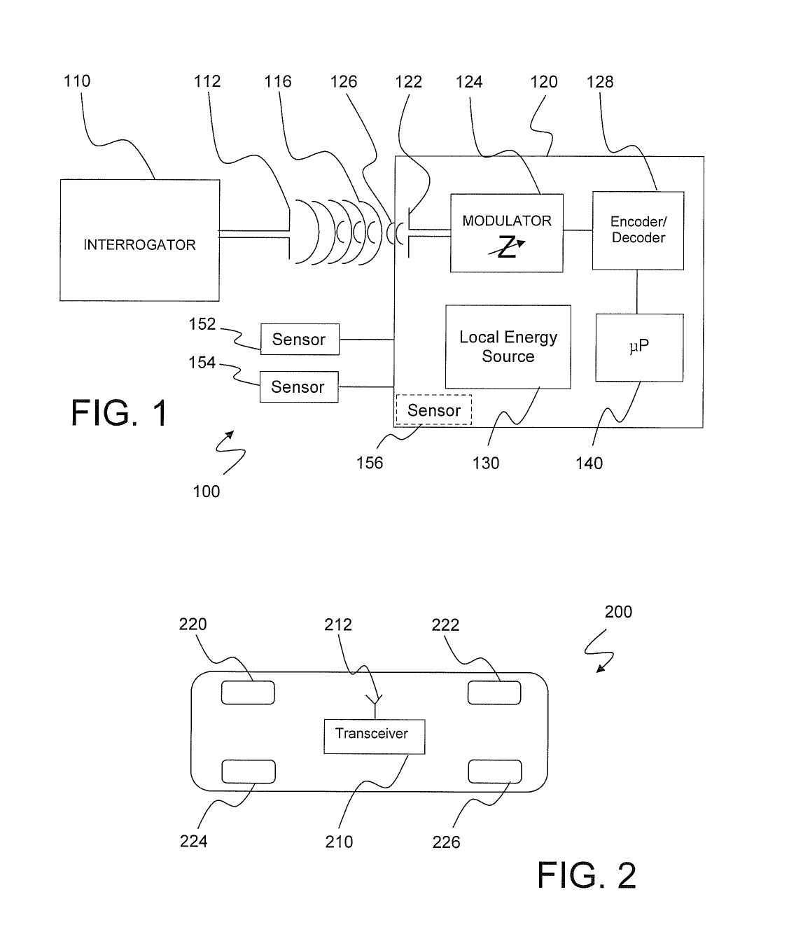

Reference will now be made in detail to the presently preferred embodiments of the subject self-powered semi-passive RFID transponder apparatus and methodology. Referring now to the drawings, FIG. 1 illustrates a transponder communications system 100 in accordance with the present technology. In operation, interrogator 110 transmits information, generally represented by signal 116, via antenna 112 to an antenna 122 of backscatter module 120. In an exemplary configuration, this information may be transmitted on an industrial, scientific, medical (ISM) frequency band ranging from 850 to 950 MHz. Upon receiving a transmission from interrogator 110, backscatter module 120 responds by modulating the impedance of antenna 122 via modulator to modify the amplitude and/or the phase of the reflected signal 126.

As will be further explained, interrogator 110 may correspond to a device mounted on a vehicle or may correspond to a handheld device or a drive by device that may be coupled to remote or more local data gathering devices or systems. In embodiments using a handheld device, the handheld device may be configured to read and store data from the backscatter module 120 for later use and/or transfer to a local or remote data gathering and/or processing device or system. Embodiments of the present subject matter associated with drive by interrogators may also store and/or process data for local or remote use or simply be configured to transmit data to a remote location for processing.

The system functions similarly to a passive RFID system, except that the energy required to power the backscatter module 120 does not come from the interrogator 110's carrier wave. Rather the power comes from a local energy source 130. In exemplary configuration local energy source 130 may correspond to a battery, a fuel cell, a radiation source, a super-capacitor, an energy harvesting device or combinations thereof. In further exemplary configurations, the energy harvesting device may correspond to one of a piezoelectric transducer, a thermo-electric transducer, and a radio frequency (RF) energy harvesting device.

As is known from the prior art, the read range of passive RFID systems is limited to the ability to power the RFID tag from the incident beam energy. Calculations have shown that 30 dB, i.e., 1000 times, more power is required to energize the tag than is necessary for the backscatter data communications. By employing the energy assist of the present subject matter, this 30 dB is gain that may be retuned to the forward link power budget. This 30 dB translates to a read range in free space of approximately 100 meters for the energy assisted tag as compared to approximately 2 meters for a passive tag.

This extra link margin can be used in several ways including: increased read range to communicate to a central vehicle interrogator, increased immunity to attenuation factors in the environment, and decreased interrogator transmitter power to reduce interference or to comply with stricter RF regulations.

With further reference to FIG. 1, it will be notice that backscatter module 120 may include an encored/decoder module 128 and a controller 140 to control overall operation of the backscatter module 120. Local energy source 130 may be configured to supply operating power to one or more of the various components of backscatter module 120 including antenna impedance modulator 124, encoder/decoder module 128 and controller 140. Those of ordinary skill in the art will appreciate that encoder/decoder module 128 may correspond to separate encode and decoder devices. Further, controller 140 may correspond to a microcontroller, a state machine, or a microprocessor and may also include one or more interfaces to sensors, memory devices, serial devices, and other devices. Sensors such as illustrated at 152, 154, 156, may correspond to sensors externally interfaced to backscatter module 120 for monitoring such as tire temperature or pressure and sensors such as illustrated at 156 internally interfaced to backscatter module 120 for monitoring selected module related parameters.

With reference now to FIG. 2, there is illustrated a vehicle 200 with a centrally located transceiver 210 and four tires 220, 222, 224, 226 each containing a transponder, not illustrated, Transceiver 212 is configured to communicate with modules in tires 220, 222, 224, 226 by way of antenna 212.

The semi-passive architecture in accordance with the present technology provides several advantages. As a preliminary matter, two-way communications can be achieved within a reasonable energy budget. Further, high update rates are possible. In an exemplary configuration updates may occur every few seconds. Advantageously there is no active RF source in the tire. Backscatter module 120 operates at the frequency of the interrogator 110 so that RF compliance by country is assured at the interrogator level rather than at the tire level so that there is no need for multiple tire module configurations to supply various configurations for multiple countries. Providing backscatter electronics alone is, of course, simpler than providing transmitter and receiver electronics. Finally, the interrogator becomes the master of communications in that it can request information from the tire module whenever needed. An additional advantage of the present subject matter when employed in a vehicle architecture is that a vehicle architecture based on passive devices requires the interrogator antennas to be in close proximity to the tire, often positioned in the wheel wells. This is unfavorable in several aspects because: 1) the vehicle system architecture becomes expensive, 2) the interrogator antennas become susceptible to damage from stones or other obstacles, and 3) the antenna and any associated wheel well electronics must operate at temperatures up to 120 degrees C.

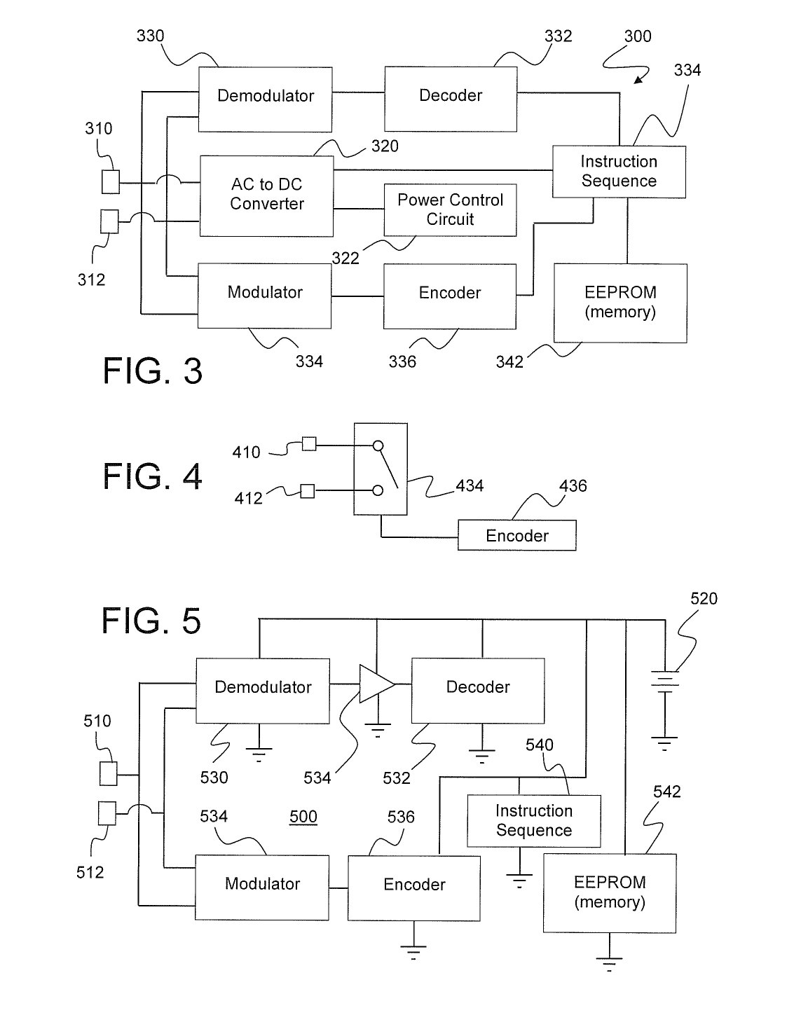

With reference now to FIG. 3, there is illustrated a previously employed passive transponder 300 configured to derive operating power from an external source by way of a antenna coupled to tag antenna connectors 310, 312. Transponder 300 is configured to receive data from, for example, an interrogator (FIG. 1) and to extract power from RF energy transmitted to them by the interrogator. An AC to DC converter 320 rectifies the received RF signal and filters the signal to remove the RF component. The resulting DC energy is used to power semiconductor circuits on the tag via power control circuit 322. Such semiconductive circuits include demodulator 330, decoder 332, modulator 334, encoder 336, an instruction sequence device 340, and a memory device 342. Each of these devices performs functions as would normally be expected by those of ordinary skill in the art. Certain of the devices, for example instruction sequence device 340, will be understood by those of ordinary skill in the art to correspond to device such as microcontrollers, microprocessors, state machines, and other similar control devices.

Tags constructed as illustrated in FIG. 3 transmit data to a reader or interrogator by using a backscatter modulation technology. At the time when the tag must communicate, the interrogator or reader sends a continuous wave signal to the tag. The tag's antenna (not illustrated in FIG. 3 but similar to antenna 122 of FIG. 1) will reflect some of the energy back to the interrogator.

With reference now to FIG. 4, there is illustrated an encoder 436 and antenna modulator 434 in accordance with the present technology. As may be seen, antenna terminals 410, 412 correspond to similar terminals (310, 312) illustrated in FIG. 3 and are used as connection points for the tag antenna. Modulator 434 corresponds to an electronically switch that modulates the impedance of an antenna coupled to terminals 310, 312 by periodically shorting the antenna terminals together under control of encoder 436. The changing termination impedance of an antenna coupled to terminals 410, 412 will result in a corresponding change in the amplitude and/or phase of the reflected signal. The interrogator (reader) intercepts the modulation on the signal to receive data from the tag. Those of ordinary skill in the art will appreciate that even though the tag generates no RF energy, it communicates by modulating the level of reflected energy incident from the interrogator (reader).

The operating range for UHF passive tags is between three to five meters. These types of tags must operate at close range to the reader because they need between 10-500 microwatts of RF power to energize their circuits. This power must come from the RF signal transmitted by the reader's antenna. Path loss between reader and tag, RF absorbing or reflecting materials in the path and RF noise reduce the power seen by the tag. Path loss is proportional to the square of the distance resulting in making range one of the most difficult parameters to achieve with RFID.

Passive tags generally require a minimum of −10 dBm (100 μW) just to power up and receives only 7 dB more than the minimum requirement. This 7 dB margin is generally not adequate for real world situations. RF noise or RF absorption or reflection may easily exceed this margin. For example, in case of the presence of water, around 25 dB is needed to penetrate and read tire tags.

Local energy assisted passive tags in accordance with the preset subject matter in vehicle environments offer much greater range and reliability than passive tags. A local energy source of DC power to the circuits in the tag eliminates the need for the tag to draw all operating power from an interrogator (reader) RF energy. With reference now to FIG. 5, there is illustrated a semi-passive transponder 500 including a local energy source 520 that, in accordance with present technology, may be used in a vehicle environment to address may of the shortfalls of the previous technology.

As illustrated in FIG. 5, semi-passive tag 500 includes antenna terminals 510, 512, demodulator 530, decoder 532, modulator 534, encoder 536, instruction sequence device 540, and memory device 542 each of which correspond in function to similarly numbered and functioning components as illustrated and previously described with reference to FIG. 3. Further, however, tag 500 includes a gain block or amplifier 534 between demodulator 530 and decoder 532 configured to amplify the received signals and thereby increase receiver sensitivity. This greatly increases the read range and reliability of these semi-passive devices.

In addition, the local energy source 520 provides power for the instruction sequence (logic) device 540, memory 542 and any other function supported on or by the tag including external and internal sensors (not illustrated in FIG. 5 but exemplarily illustrated in FIG. 1). Those of ordinary skill in the art should appreciate that while the local energy source 520 is symbolically illustrated herein using a standard battery symbol, such is not a limitation of the present technology. As previously discussed above, local energy source 520 may correspond to a battery, a fuel cell, a radiation source, a super-capacitor or a rechargeable battery. Further, local energy source 520 may correspond to energy harvesting devices including piezoelectric devices, thermo-electric transducers, and RF energy harvesting devices including combinations of internal devices with initiators mounted in vehicle wheel wells, hand held type devices, and drive-by units.

With further reference to FIG. 5, it should be appreciated that data is sent to an interrogator (reader) using the same backscatter techniques as passive tags. Unlike active tags which are actually transmitters that require governmental approval (i.e., from the Federal Communications Commission (FCC) in the U.S. and similar agencies in other countries), local source assisted or semi-passive tags reflect the signals sent by the interrogator (reader). No RF energy is generated in the tag. Further the local power source is used solely for powering the various semiconductive devices (chips) forming the tag and, possibly internal and external sensors associated with the tag.

Use of the present technology in conjunction with vehicle mounted systems results in several benefits based on increased link margin for local source assisted passive tags. A first benefit corresponds to a greatly extended tag range. While the tag read distance from the backscatter transmissions to the interrogator (reader) is substantially the same for both passive and semi-passive tags, semi-passive tags in accordance with present technology provide a greatly extended forward link (i.e., interrogator to tag) enabling this extra power to increase operating range to greater than twenty times that of standard passive tags. This added link margin can be used to ensure accurate read and write in adverse RF absorbing or noisy environments. Further still, the interrogator RF power, and therefore potential interference to other radio systems sharing the same spectrum, can be reduced to communicate with tags less than one hundred meters away. Finally, the increased read range allows for centralized interrogators on a vehicle. This has the advantages of: 1) reducing overall system costs and 2) allowing the vehicle interrogator(s) to be centrally located in a protected part of the vehicle away from the wheel wells where high temperatures and road obstacles could damage the unit(s).

While the present subject matter has been described in detail with respect to specific embodiments thereof, it will be appreciated that those skilled in the art, upon attaining an understanding of the foregoing may readily produce alterations to, variations of, and equivalents to such embodiments. Accordingly, the scope of the present disclosure is by way of example rather than by way of limitation, and the subject disclosure does not preclude inclusion of such modifications, variations and/or additions to the present subject matter as would be readily apparent to one of ordinary skill in the art.

What is claimed is:

1. A semi-passive transponder system, comprising:
a vehicle;
at least one semi-passive backscatter module associated with said vehicle; and
an interrogator module,
wherein said semi-passive module includes an antenna, an antenna impedance modulator, a data encoder, a data decoder, a memory, and an internal energy source, and wherein said internal energy source supplies power to at least said antenna impedance modulator.

2. The system of claim 1, wherein said at least one semi-passive backscatter module is located within at least one tire mounted on said vehicle.

3. The system of claim 1, wherein said internal energy source comprises one of a battery, a fuel cell, a radiation source, a super-capacitor, a piezoelectric transducer, a thermo-electric transducer, a radio frequency (RF) energy harvesting device, and combinations thereof.

4. (canceled)

5. The system of claim 1, wherein said interrogator module further comprises at least one antenna, a transceiver, a data encoder, and a data decoder.

6. The system of claim 1, further comprising:
at least one peripheral device associated with said vehicle and interfaced with said at least one semi-passive backscatter module,
whereby additional data may be transmitted to said interrogator module.

7. The system of claim 6, wherein said peripheral device comprises one of a sensor and a microcontroller.

8. The system of claim 1, wherein said internal energy source further supplies power to a said data encoder, said data decoder, and said memory.

9. The system of claim 1, wherein said interrogator is provided as one of a vehicle mounted device, a handheld device, and a drive by device.

10. (canceled)

11. (canceled)

12. A method for providing improved communications in a vehicle mounted back-scatter transceiver system, comprising:
providing a vehicle;
providing a semi-passive backscatter module by providing an antenna, an antenna impedance modulator, a data encoder, a data decoder, a memory, and an internal energy source for providing energy to at least the antenna impedance modulator;
associating at least one semi-passive backscatter module with the vehicle; and
providing an interrogator module for initiating communications with the semi-passive backscatter module.

13. The method of claim 12, wherein associating at least one semi-passive backscatter module with the vehicle comprises:
providing a tire;
associating at least one semi-passive backscatter module with the tire; and
mounting the tire on the vehicle.

14. The method of claim 12, wherein providing an internal energy source comprises providing one of a battery, a fuel cell, a radiation source, a super-capacitor, a piezoelectric transducer, a thermo-electric transducer and a radio frequency (RF) energy harvesting device, and combinations thereof.

15. (canceled)

16. The method of claim 12, wherein providing an interrogator module further comprises providing at least one antenna, a transceiver, a data encoder, and a data decoder.

17. The method of claim 12, further comprising:
providing at least one peripheral device;
associating the at least one peripheral device with the vehicle; and
interfacing the at least one peripheral device with at least one semi-passive backscatter module.

18. (canceled)

19. The method of claim 12, further comprising:
providing energy from the internal energy source to one or more of the data encoder, the data decoder, the memory, and combinations thereof.

20. The method of claim 12, further comprising:
providing the interrogator as one of a vehicle mounted device, a handheld device, and a drive by device.

21. (canceled)

22. (canceled)
